(19) United States
(12) Patent Application Publication
(10) Pub. No.: US 2013/0079036 A1
(43) Pub. Date: Mar. 28, 2013

(54) SYSTEM AND METHOD FOR TARGETED LOCATION-BASED ADVERTISING

(71) Applicant: Hertzel SHARET, Tel Aviv (IL)

(72) Inventor: Hertzel SHARET, Tel Aviv (IL)

(21) Appl. No.: 13/245,996

(22) Filed: Sep. 27, 2011

(51) Int. Cl. H04W 64/00

(52) U.S. Cl. 455/456.3

(57) ABSTRACT

A media streamer providing multiple-network connectivity including both Bluetooth® and Wifi™ connectivity. The appliance allows mobile devices to surf the internet, and allows the owner of the device to advertise on these mobile devices. By identifying individual mobile device, the appliance allows targeted advertising, for example making use of MAC address for target identification. The appliance allows for a location-based advertising experience, since the range of wireless connectivity it offers (such as BlueTooth® and WiFi™) each have well-defined spatial extent. By use of several such appliances a location- and history-aware advertising experience can be provided.

### BACKGROUND

1. Technical Field

Embodiments of the present invention relate generally to systems and methods for targeted location-based advertising.

2. Description of Related Art

Advertising in its various forms slowly invades the new ecological niches created by technological advance. A case in point is advertising through Wifi™ and Bluetooth® technologies. Wireless advertising systems do exist currently—for example a ‘Hotspot Management System’ runs on a router or an external computer and authorizes only specific users to access the Internet. They often associate the free access with a menu or a purchase limit. Current commercial hotspots may feature a captive portal or login procedure to which users are redirected for authentication, registration and/or payment, a ‘walled garden’ allowing free access to certain sites, and service oriented provisioning to allow for improved revenue.

A number of applications deal with WiFi/BT technology and broadcast of ads thereby. For instance US20090257416A1 provides:
An access point has a connection to a wide area network, and is configured to allow a device to connect thereto, and includes an Application Programming Interface for allowing a remote application to connect to the access point over the wide area network, and to obtain information relating to the device connected to the access point. In particular, the access point is configured to allow a device to connect thereto over a wireless interface, and to provide bearer translation such that traffic over the wireless interface can be directed over the wide area network. The Application Programming Interface may then allow the application to obtain information relating to a connection status of a wireless device associated with the access point.

In this example of course there is no provision for Bluetooth® nor device—aware advertising. Similarly methods for use of WiFi/WAP abound as well. For instance WO0251080A1, “Method, system, gateway, proxy and computer program for adding information to received content pages” provides:
A method . . . for mobile terminals (106) to request WAP content from a network (102). The network comprises a gateway (106) via which a mobile terminal having a display can access a plurality of content servers (110, 118) each having stored therein content pages. The network is run by a network operator. The mobile terminal sends a request to the gateway for a content page to be provided by one of the content servers and the gateway obtains the content page and provides it to the mobile terminal. Before doing this, the gateway uses a WAP content proxy (112) to insert into the content page a link to a home page of the network operator which thus enables a user of the mobile terminal always to have presented a link option to go to the network operator's home page.

This provides a technique whereby ads may be served; however for instance use of multiple communications is not disclosed, nor is targeting by device address discussed.

Systems specifically designed for targeted adverstiting campaigns are also abundant in the literature, albeit again these tend to target either cellphones or wireless devices (in the sense of wireless network LAN users such as laptops), but not both. As an example consider EP1968002A1 for “Charging or billing depending on the reaction to an advert received by a user”. This applications discloses:
System and method for running advertising campaigns for mobile phones. Monitoring the reaction to the received advert and billing the advertiser depending on the reaction. . . . An apparatus receives information regarding communications and messages in a communications network. In response to receiving transmission information relating to a communication from a user terminal, the apparatus . . . sends an output to a telecommunications arrangement in the case that it determines that such a message has been sent. . . .

While providing for a system of mobile advertising suitable for cellphones, the system does not account for other mobile devices such as PDAs, laptops, tablets, and the like. The multiple-network Bluetooth+Wifi(tm)system is not touched upon, nor is targeting by device address addressed. Hence, an improved method for targeted advertising is still a long felt need.

### BRIEF SUMMARY

The device is a media streamer providing multiple-network connectivity, in some embodiments comprising Bluetooth® and Wifi™ connectivity. The device allows for targeting by means of device address, for example making use of MAC address for target identification. The device by its very nature allows for a location-based advertising experience, since the range of wireless connectivity it offers (namely BlueTooth® and WiFi™) each have well-defined spatial extent.

An aspect of the invention provides an advertising system comprising:
a. a plurality of media streamers adapted for providing wireless connectivity to mobile devices;
b. a server in networked communcation with said media streamers;
c. a database of advertising content on said server;
whereby advertising content may be sent to mobile devices by means of media streamers.

It is further within provision of the invention wherein said wireless connectivity is selected from the group consisting of: BlueTooth®, WiFi™.

It is further within provision of the invention wherein said mobile devices are selected from the group consisting of: Turing machine, cellphone, smartphone, PDA, laptop computer, desktop computer, tablet computer.

It is further within provision of the invention wherein said advertising content is selected from the group consisting of: html pages, images, video, text, audio.

It is further within provision of the invention wherein said server is provided with software associated with said advertising system adapted to serve said advertising content to said media streamers.

It is further within provision of the invention wherein said media streamers are organized into zones, these being logical groups of media streamers.

It is further within provision of the invention wherein said advertising content is sent to said mobile devices by said media streamers based on criteria selected from the group consisting of: MAC address, media streamer location, mobile device connection history.

It is further within provision of the invention wherein said media streamers are adapted to query said mobile devices regarding connection details selected from the group consisting of: whether to connect; connection speed; connection protocol; connection language.

It is further within provision of the invention wherein said media streamers are adapted to record information selected from the group consisting of: mobile device MAC address, mobile device type, mobile device operating system, mobile device software information, mobile device query response.

It is further within provision of the invention wherein advertisers may modify said advertising content.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

In order to understand the invention and to see how it may be implemented in practice, a plurality of embodiments will now be described, by way of non-limiting example only, with reference to the accompanying drawings, in which:

FIG. 1 depicts a system diagram consistent with an embodiment of the invention,

FIG. 2 depicts a system diagram consistent with an embodiment of the invention,

FIG. 3 depicts a system diagram consistent with another embodiment of the invention having several media streamers, and

FIG. 4 depicts a system diagram consistent with an embodiment of the invention having several media streamers daisy-chained.

### DETAILED DESCRIPTION

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a means and method for providing a system and method for targeted location-based advertising.

In the following detailed description, numerous specific details are set forth in order to provide a thorough understanding of embodiments of the present invention. However, those skilled in the art will understand that such embodiments may be practiced without these specific details. Reference throughout this specification to “one embodiment” or “an embodiment” means that a particular feature, structure, or characteristic described in connection with the embodiment is included in at least one embodiment of the invention.

The term ‘plurality’ refers hereinafter to any positive integer (e.g, 1, 5, or 10).

The term ‘BlueTooth®’ refers hereinafter to a proprietary open wireless technology standard for exchanging data over short distances (using short wavelength radio transmissions in the ISM band from 2400-2480 MHz) from fixed and mobile devices. This standard is used for creating personal area networks (PANs) with high levels of security.

The term ‘WiFi™’ refers hereinafter to any device or system using the IEEE 802.11 family of standards, and to the mechanism of the same name for wirelessly connecting electronic devices. A device enabled with WiFi™, such as a personal computer, video game console, smartphone, or digital audio player, can (for example) connect to the Internet via a wireless network access point. An access point (or hotspot) has a range of about 20 meters (65 ft) indoors and about 100 meters (325 ft) range outdoors. Multiple overlapping access points can cover large areas.

The term ‘wireless’ refers hereinafter to any means of cable-free connection including BlueTooth®, Wifi™, infrared, optical means (other than optic fiber), and any other mean of cable-free connectivity including sonic, electromagnetic, and gravitational.

The term ‘mobile device’ refers hereinafter to any portable object capable of acting as a Turing machine, including cell phones, smartphones, PDAs, laptops, tablets, and the like. Generally these devices will be provided with wireless connectivity of some sort such as BlueTooth® or WiFi™.

The inventive device is a media streamer providing multiple-network connectivity between devices. The devices involved in this connectivity include but are not limited to mobile devices such cell phones, smartphones, PDAs, laptops and others, and the internet, local networks, LANs and the like. In some embodiments the inventive device comprises both Bluetooth® and WiFi™ connectivity. The device allows for targeting by means of device address, for example making use of MAC address for target identification. Due to the limits of spatial extent of Bluetooth® and WiFi™ connectivity, the device can be used inter alia for location-specific advertising.

The characters involved in use of the system include the system operator, a plurality of advertisers, and a plurality of bandwidth-consumers. The infrastructure or physical hardware includes a plurality of ‘media streamers’ or physical devices, a plurality of networked servers, and the hardware infrastructure required for linking the media streamers and servers.

The inventive device acts as a sort of all-purpose ‘internet source’—it functions as a wireless access point suitable for Wifi™ connections, Bluetooth® device, IR device, and the like. It has upstream connectivity through a number of means as well including Ethernet cable connection, wireless modem, cellular modem, satellite modem, etc. It can further act as a television/video controller. By means of the WiFi/Bluetooth/IR connections, users can enjoy internet service through the device. These users can be (for instance) customers in a café, riders on a train, etc.

By means of the device, ads may be served to the various consumers of bandwidth connected thereto. These ads may be served upon connection, continuously, upon leaving and/or entering certain locations, and the like. This may be accomplished by use of two or more physical devices of the invention for example covering the area of a mall. As a user passes through the mall, wireless connectivity passes from one physical device to the next. As each physical device of the invention is ultimately connected to a central network such as the internet, intelligent advertising may be executed that utilizes information concerning the bandwidth-consumers' movements. For example a welcome message may be sent upon entering the mall, an exit message may be sent upon exiting, and a series of ads may be sent as the user passes by various stores or locations in the mall.

Software is provided on a server adapted for controlling the physical devices of the invention. Ads are served through the devices, for instance being sent to users as the first webpage seen during a browsing session and/or as Bluetooth® files (after appropriate requests). These ads are managed through a web interface running on servers associated with the system. Since the system is necessarily linked to a physical location, ads can be tailored to specific locations, a technique hereinafter referred to as Location Based Marketing (LBA).

Thus the invention comprises two parts—a hardware device having a CPU, Wifi™ capability, Bluetooth® capability, as well as video, audio, USB, etc.; and a software part, whereby internet access is granted and ads are served to people in the proximity of the device. The combination can also be thought of as a method for wireless advertisement to passersby.

A number of differences distinguish between the inventive method and (for example) existing Wifi™ hardware, including but not limited to:
a. use of both Wifi™ and Bluetooth;
b. TV capability;
c. large amount of local storage.

The invention allows for dynamic content to be served, for instance consisting of a stream of video, audio, web pages or the like. It is further within provision of the invention to collect surfing statistics which allow system operators to observe aggregate and individual statistics associated with the device. It is also within provision of the invention to facilitate device specific advertising, for example by means of MAC-address or other device-specific address. This provision allows system operators to target ads at specific users and/or devices, based on their history or the like (for instance broadcasting a welcome greeting as they enter a mall and a goodbye message as they exit, and ads during their stay that are based on their previous browsing history.

It is further within provision of the invention that the physical device of the system be updated periodically, having enough local storage (for example on the order of gigabytes) to serve a large amount of information which is refreshed when internet access is available from central servers associated with the system. Advertisers send content to these servers using a special-purpose bespoke web interface.

The invention thus provides location based advertisement and marketing solutions. These ads may optionally be generated based on the actual location of the end users, and may be delivered to mobile devices for example via Bluetooth® and Wi-Fi communication. The solution includes end point physical devices or media streamers which may be disposed at any location having internet connectivity. The invention further comprises a server unit which is adapted for managing the system, and which enables the end point media streamers to operate in an intelligent, location-aware and history-aware fashion.

The system is in one embodiment controlled and managed via a web-based front end, allowing both system operators and advertisers to control their respective portions of the system.

By means of software having for example a web interface running on servers associated with the system, advertisers may manage multiple media streamers which are arranged within different physical or logical locations or ‘zones’. The advertiser can also create advertising campaigns with content of choice, including transferrable files such as image, video, audio, text, and the like. Each advertising campaign is associated with one or more media streamers and is schedule to run at specific times and on specific media streamers.

The invention relies on two basic units, these being the media streamer and the zone. The media streamer is the physical device of the invention, which connects to the internet on the one hand and allows for other devices to connect to the internet on the other hand, acting for instance as a WiFi™ wireless access point. The media streamer is the actual unit which interacts with the end user device—mobile phone, smart phone, PDA, laptop. The zone is a groups of media streamers which are treated as a logical group.

The media streamer is provided to an advertiser with a built in license valid for a given time period, starting upon activation. Thereupon the user may purchase extended license for additional time. The media streamer may optionally be located at location without constant internet connection.

Possible activities done at the media streamer level comprise:
a. Pull a Campaign from the server every time interval
b. Pull the Interaction list for the campaign (For Shared Campaigns only)
c. Send information back to the server—Interaction List and Status
d. Update Media streamer software installed

When viewing the media streamers screen, it is necessary to have the option of sorting the list by each column.

It is within provision of the invention that the media streamer be operated with the following considerations:
a. Active for a certain range—RSSI
b. Serving Order of Devices—Nearest, First In-First Out
c. Time Zone—Schedule are treated based on Media streamer time zone
d. Expired Media streamer—When there is no valid license for the media streamer

It is further within provision of the invention that each media streamer be provided with the following parameters:
a. Id, Name and Description
b. Geographic location—For customer use only
c. Phone Prioritization—Who is first to serve: Nearest, FIFO

The detail information each media streamer receives from the server comprise the following:
a. Sync Interval—Next time client should receive an update
b. The file to be transmitted to the user device
c. Date and Time when campaign should be stopped
d. Interaction List of the its zone—if need to share Interaction List

Additionally each media streamer has provision to transmit to the server the following information:
a. Interaction list created
b. Ping/Live Message—with status

The following list outlines the different steps that occur within the media streamer and device interaction, in certain embodiments of the invention:
1. Media streamer receives the MAC address for device in range
2. Media streamer sends “Do you want a message from XXX” displayed for N1 seconds
3. If no response, wait N2 seconds, and repeat step 2
4. If no response, continue with step 2 & 3 for N3 Times
5. Wait N4 after interval, Repeat step 2, 3 and 4
6. Yes→Add to yes list and send content
7. No→Add to no list
8. Failed→Failed to send, go to failure list
9. Resend Confirmed—Time for Yes List for the same campaign—N5
10. Resent Rejected—Time for No list for the same campaign—N6
11. Resent Failed—Time for resending unrealized Yes—N7

By control over the times N1, N2 and N3, system operators and advertisers may adjust between number of people served, and time in range.

It is further within provision of the invention to allow:
a. Media streamer Configuration Template to be selected for certain locations
b. Get the Type of phone/O.S./vendor from the device

In essence the zone is a group of media streamers which has in common one of the following:
a. Geographic location specific
b. Chain of stores in different locations

The zone is used to associate a campaign with one or more media streamers. The zone has the following properties:
a. List of Media streamers associated with it
b. Id, Name, Description

The advertiser buys, rents or otherwise obtains media streamers to be used for purposes of providing net connectivity, ad distribution, and the like. It is within provision of the invention that these media streamers be managed within logical groups called Zones. Each Zone may have 1 or more media streamers associated with it, and each media streamer may be associated to a number of media streamers.

The operations performed by the advertiser desiring to configure the system comprise:
a. Log into the system servers for example by means of user name and password, as for example controlled by system operators.
b. Get account information (such as password) by email
c. Define a new media streamer in the advertiser account—for instance by entering an activation key provided by the system operator for this purpose
d. Connect a media streamer to the internet and confirm that it is available for use
e. Create a zone, based on one or more media streamers in the system
f. Upload files such as advertising files to the account, for use with campaigns on one or more media streamers and/or zones, the files comprising for example image, music, and other supported content
g. Create advertising campaigns and associate these campaigns with one or more media streamers and/or zones.
h. View statistics of the campaign(s) underway.

Statistics available to advertisers of the system include, for example, number of times a given file is served and through what means (WiFi, Bluetooth® etc), number of connections and type, web use statistics, and the like.

Bandwidth consumers or end users of the system may have several types of interaction with the inventive system:
a. The end user is contacted passively—without any action on his side
b. The end user requests access to a wireless network in the area

In either case, the user would for example first be served an ad from the system, which may comprise one of the following file types:
Image—JPEG, GIF, or other image format
Video—in any format such as 3GP, avi, mov, qt, fla and the like
Music—MP3, ogg or the like
Java File (Application)
WAP Link

The ad content may optionally include (for example) an image with a logo of a company.

An end user possessing a Bluetooth® device may be prompted by a media streamer of the system. The prompting is in keeping with the Bluetooth® protocol, to the effect of querying whether the end user is in fact willing to get a message form a certain Advertiser. This would occur for example in the form of a question sent over the Bluetooth® link to the effect of : “Do you want to get a message from XXXX?”.

If the end user replies in the negative, nothing would happen until the next attempt to send an ad to this user. Alternatively if the user replies in the affirmative, an ad would be sent to him in the form of a file, text, or the like. In any case the end user is periodically prompted in this fashion based on predefined settings stored in the media streamer and/or server of the system, and determined by the advertiser and/or the system operator.

It is assumed for purposes of operating the system that the mobile device borne by the end user supports the type of the file being sent over the existing communications link, for example being supported by the Bluetooth® protocol if being sent by Bluetooth. For the case of Wi-Fi, the user is able to view the actual content based on the support given by the mobile device hardware and software being employed in that particular case.

An end user bearing a device having Wi-Fi support is able to access the network to surf the internet. Assuming the user selects a particular media streamer of the system to facilitate his/her connection, amongst the data sent to this user would be (for example) an ad page constructed (for example) by an advertiser of the system.

The user should is exposed to the content of the ad, in some embodiments of the invention, on the first page presented, this being referred to hereinafter as the ‘landing page’. This would be either an actual view of the image representing the ad or a link or other means for downloading the file in question onto the mobile device(s) borne by the end user.

The actual experience of the user of the content presented to him would is based on the hardware and software configuration of the mobile device, for example browser support and the like. The page displayed may comprise for instance low resolution elements for use with small screens; the information sent may be sent at different resolutions to different devices based upon the known or assumed hardware configuration of these devices as determined by query, metadata, lookup table or the like as will be clear to one skilled in the art.

The same content albeit at possibly different resolutions may be used for connections using either the Bluetooth, Wi-Fi, or any other communications protocol being ads.

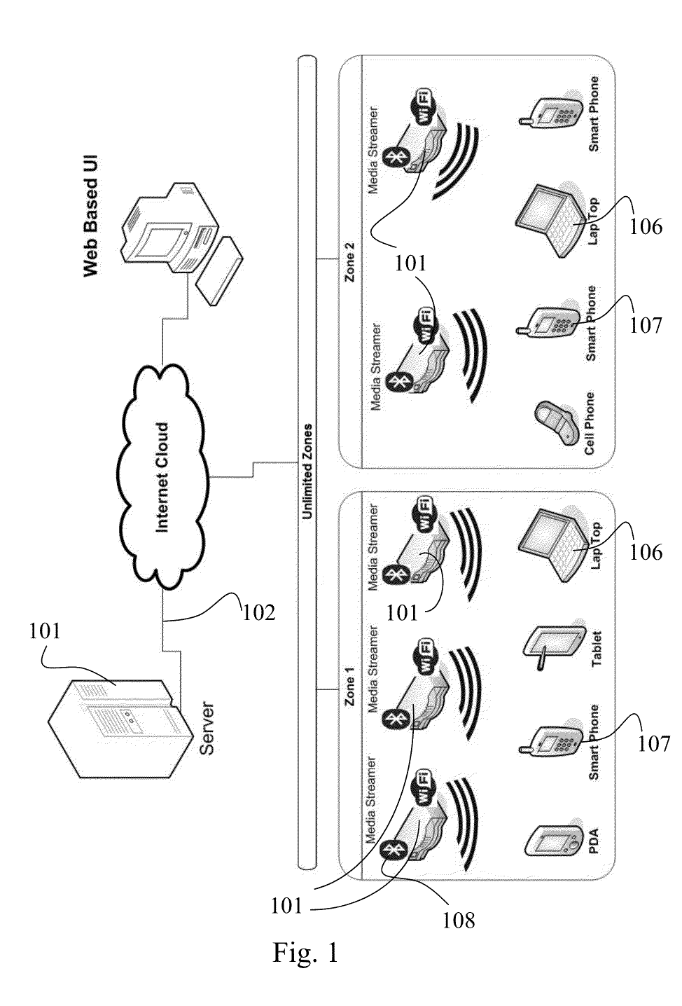

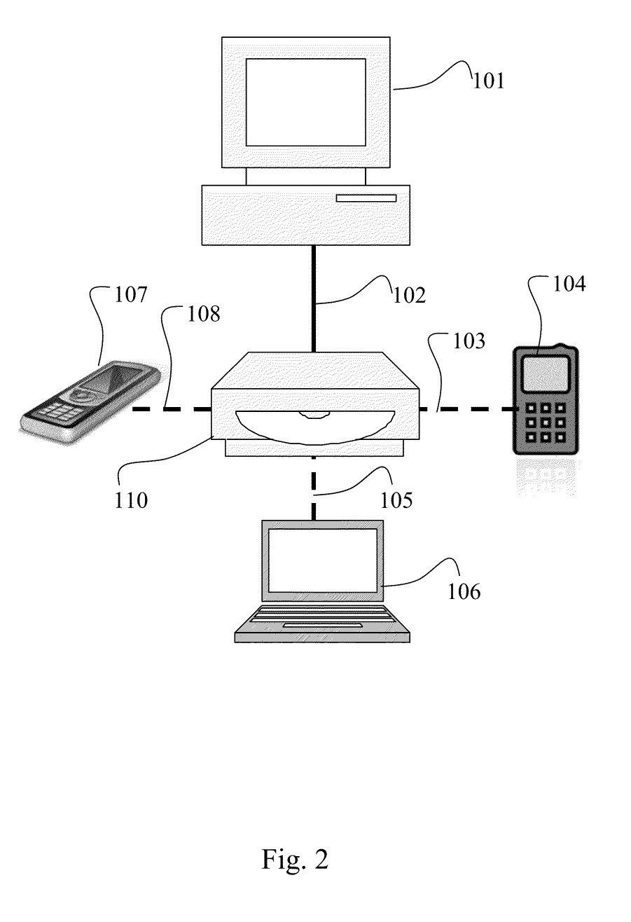

We now refer to FIGS. 1 and 2 which is a system diagram of one embodiment of the invention. A server associated with the system 101 is connected through an internet connection 102 to the media streamer 110 of the invention. This media streamer 110 connects to various mobile devices simultaneously, in this example connecting to a mobile phone 107 through a BlueTooth® connection 108, to a laptop 106 through an infrared connection 105, and to another cellular device 104 through a WifI™ connection 103.

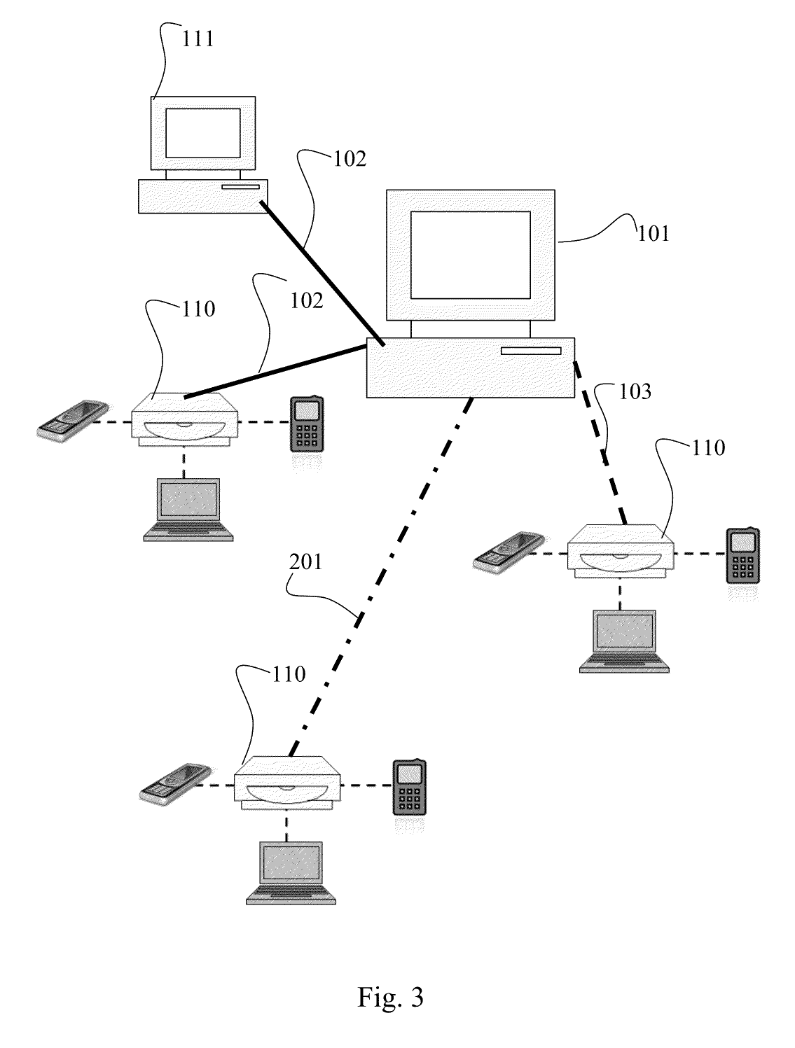

We now refer to FIG. 3 which is a system diagram of another embodiment of the invention. A server associated with the system 101 is connected through an internet connection 102 to multiple media streamers 110 of the invention. An advertiser/content provider 111 connects to the server 101 of the invention through an internet connect 102 in order to upload ad campaigns which are stored on the server 101 and from there forwarded to the media streamers 110. As before the media streamers 110 connect to various mobile devices simultaneously. In this example several different connection means are used for purposes of connecting the server 101 to the media streamers 110, notably internet connection 102, WiFi™ connection 103, and cellular connection 201.

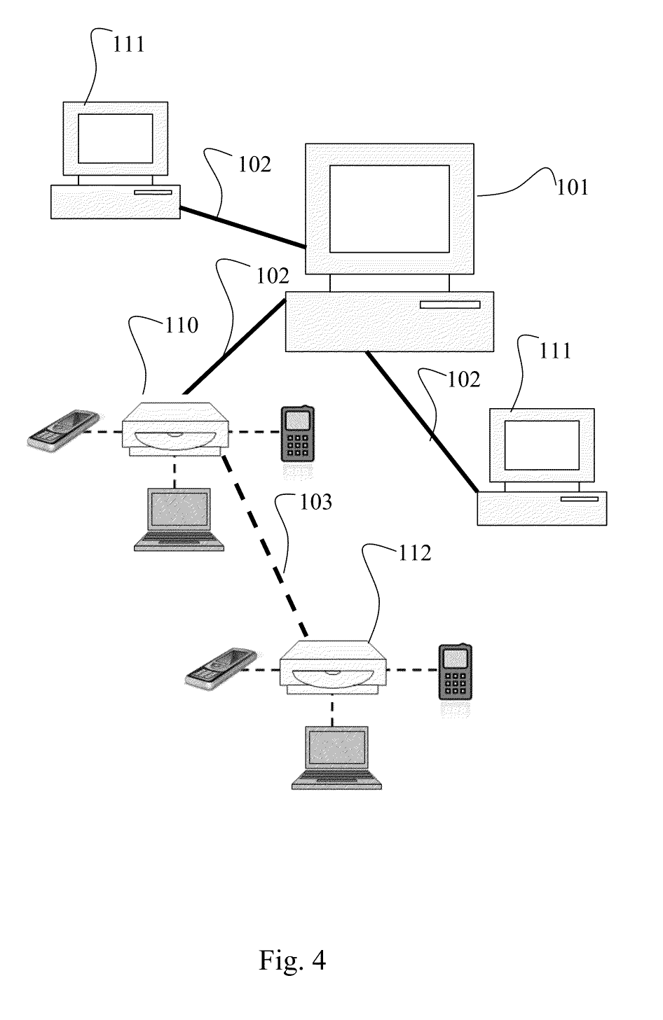

As will be appreciated, since the media streamers of the invention are capable of receiving and sending bandwidth, it is within their capability to be ‘daisy-chained’ such that one media streamer may connect on the one hand to the server of the system and on the other hand may provide bandwidth to another media streamer of the invention. This is shown in FIG. 4 where the advertisers 111 connect to server 101 through net connections. The server 101 in turn connects to media streamer 110, which may in turn provide bandwidth to other devices 112 ad infinitum. The connection 103 may be of any sort which the devices support, including but not limited to Ethernet, cable connection, Wifi™, BlueTooth®, infrared, optical, and the like.

An advertiser of the system may define various ad campaigns by assigning different operations to different zones and/or media streamers. Each ad campaign may comprise the following information:
a. Id, Name and Description
b. “Transmitter Name”—Name as it appears when initial message sent to device
c. Content to be distributed when the Campaign is active (comprising one or more files)
d. Schedule—Times during which a particular ad campaign would be active within a specific zone
e. The Zone and Media streamers where the Campaign is active
f. Statistics: Interaction List—Received, Confirm, Reject, Failed
g. Export Statistics into comma delimited file
h. Campaign Enabled/Disabled—Customer can enable/disable the campaign at any time
i. The advertiser can define and change any time the SSID for the Wi-Fi connection
j. The advertiser can define the time period when the system will disconnect the end user while he is using the Wi-Fi. For example, several different options might be: no disconnection, disconnect after 10 minutes, disconnect after 20 minutes, disconnect after 30 minutes, etc.
k. Get the list of participating media streamers with this campaign by clicking

The servers associated with the system allow the advertiser to create one or more repositories of files to be used as the actual content for a campaign. Possible operations for maintenance of this repository include:
1. Upload supported file: Image, Video, Audio, Java, WAP link
2. Delete a file previously uploaded to the system
3. List all files uploaded with file preview.

Certain hardware limitations may be applied for transfers facilitated by the system, for example enforcing a maximum file size uploaded by advertisers, a maximum number of files, and the like.

It is within provision of the invention that the following files can be used as content for an ad campaign:
a. Image JPEG or GIF
b. Video 3GP
c. Audio MP3
d. Java File (Application)
e. WAP Link (such as a URL)

As will be clear to one skilled in the art the actual experience of the user would be determined to a large extent by the hardware and software configuration of the mobile device being employed by the end user, for example the memory, processor, speed, O.S., and browser used.

It is within provision of the invention that an advertiser may determine a schedule for an ad campaign, consisting for example of a set of start dates/times and end dates/times. These start and end dates and times would apply to a media streamer based on the time zone of the media streamer rather than the time zone where the user defines the campaign. This means that the actual schedule of a campaign can be at different times for media streamers located in different time zone.

it is within provision of the invention that an ad campaign can be associated with any media streamer so long as there is no overlap with the time based on actual schedule applied to each media streamer.

When a media streamer is added to the campaign or alternatively when the schedule of the campaign modified, it is within provision of the invention that the software running on the server associated with the system would check that there is no overlap in campaign time for each media streamer involved.

It is within provision of the invention that the media streamers of the invention be supplied with independent memory and computation means, such that in the event that the connection to the server 101 is severed, they may still serve content including stored web pages and advertisements of the invention. Furthermore they may initiate alternate connections such as wireless connections to the internet (for example using cellular modem, satellite modem, etc) for purposes of providing uninterrupted bandwidth to the mobile devices connected thereto.

It is within provision of the invention that the media streamers be capable of streaming video and audio content, and may for example be connected directly to a monitor and/or speakers for purposes of displaying content to passersby, whether they have mobile devices or not.

The outcome of a given ad campaign includes the gathering of certain data including:
a. Interaction lists—Actual devices (unique per list type) which have participated in the campaign
b. Statistics—The statistics of participation in the ad campaign

Interaction lists as described above may be managed per media streamer. Each media streamer is adapted to manage its interaction list for a given ad campaign. Alternatively the interaction list may be shared between all the media streamers of a specific campaign.

There are 4 types of lists managed as Interaction lists:
a. Identified—List of mobile devices which have been identified by the system
b. Confirmed—List of mobile devices and/or users who have approved receipt of ad content
c. Rejected—List of mobile devices rejecting receipt of ad content
d. Failed—List of mobile devices failing to transmit after confirmation
   Such lists may be based on identifying the MAC address of the device or use any other identification method as will be appreciated by one skilled in the art.

Interaction lists may be provided both per campaign and/or per media streamer, although in some embodiments not per zone since individual media streamers can be assigned to campaign. When statistics are viewed, the advertiser may filter by campaign, by media streamer, or otherwise. Sharing is done in the level of the ad campaign.

It is within provision of the invention to receive certain information from various devices including:
a. Mac Address—Uniquely identifies the communication hardware
b. Cell phone vendor and model, as may be available
c. Potentially other information, as may be available
d. Hardware version
e. OS version
f. Browser version
g. Other software information
h. Context information
i. Location information
j. Language information

An interaction list of the device comprises the following information:
a. Mac Address
b. Advanced: Vendor, O.S. (Version 2)
c. Date and Time (When multiple record, keep most recent)
d. Response from user: Confirm, Reject (Multiple responses are possible)
e. Retry operations—Duplicate or Unique?

The interaction list for certain connection types such as Wi-Fi may optionally include only views of ads (such as Impressions/Views by users). If the Mac Address or other identifying information is available, it will be also included in the information of the Wi-Fi interaction list.

The Interaction lists are kept on the server until the campaign is removed.

Note that in the case of Wi-Fi communication, only one list is necessary which is equivalent to the “Confirmed” list in the case of Bluetooth®—assuming this information would be available for use at a given Media streamer.

Statistics available for advertiser use are presented to the advertiser on a per-campaign basis. Thus for instance there may be provided a real-time continuously updated graph which represents the accumulated results for a given campaign. Furthermore other graphs and information display may be provided, for example a graph which demonstrates the interaction list levels over time. The lines in the graph represent the different measures in terms of the basic interaction lists recorded in the system.

An accumulated bar graph may be presented representing such information as number of end users Identified, Accepting ads, Rejecting ads, and Failing communications as described above.

Another graph possibly available to advertisers of the system comprises running results of Interaction list levels over time. This may take the form of a

Cartesian graph with X axis being the Time span, and Y axis being the level or number of hits. The actual graph here is the level of hits for the following situations:
a. Contacted (Identified)—Blue graph
b. Accepted (Yes)—Green Graph
c. Refused (No)—Red Graph
d. Interacting (Yes+No)—Yellow Graph
e. Downloaded (Yes−Failed) Magenta
f. Wi-Fi—Views/Exposure/Impression

Further reports available to the users of the system include at least one of the following:
a. Trends report per given time period (such as day, week or month etc), such report will reveal the “Pick Times” and similar information.
b. Repeated exposure report that will reveal how many times a certain user was exposed to a certain campaign or ad. For example, such report may show the groups of users that watched a certain campaign 2 times, 5 times, 20 times etc.
c. Device and brand report that will reveal the exposure of campaign or ads per particular device, brand or model.

Said reports may be available to any user of the system, as per the system operator and/or permitted users. For example, in case of a user of the system which is a distributer, he may allow his client, for example a brand management company or a marketing manager in a company, to view said reports of the system.

The advertiser in certain embodiments of the invention may access a given graph by either Campaign or media streamer index.

In one embodiment of the invention a Display Graph is provided showing Daily, Weekly, Monthly information.

In one embodiment of the invention a Display Graph is provided based on From Date and to Date

In one embodiment of the invention a Media streamer Operation and Zone graph is provided.

It is within provision of the invention that advertisers and system administrators be given control over the system including subsets of the following capabilities:
1. Create new client
2. Activate a media streamer into the system—Insert MAC, print page
3. View Clients, Media streamers and Campaigns
4. Generate media streamer license for a 1, 3, 6 and 12 month (Media streamer in depended)
5. Enable/Disable Media streamer View Statistics of any Campaign
6. Whatever the customer can see, administrator would like also to see

Note that initial activation for a media streamer enables a certain time period of normal operation. After that period expires, the system administrator is able to generate an extended license for a media streamer for an additional period of time, giving this extended access for example by means of an activation code sent to the advertiser by e-mail, SMS or other means. At this time the advertiser would be able to associate the license with any media streamer of his choice which has expired. This will enable the client media streamer based on the original license attached to the media streamer.

As described above there are 4 main players in the inventive method, these being:
System operator
Customer—Supplier of Ad Services
Advertisers—Companies which would want to post ad with the Ad Solution
Mobile User or End User—Target Audience for Ads

The following explanation emphasizes not only the requirements from the process point of view, but also the different actual users involved in the process. Therefore the specification process emphasizes the people and their objectives rather than the functional process.

The functions of system administration include but are not limited to:
Create a new client in the system
Define different trademarks and logos for different advertisers to be shown in “Landing Pages” available to the end user of the system
View all Clients, Zone, Media streamers in the system per customer
Register (Define) new media streamers per customer
Generate new activation key for each media streamer together with short user manual as seen in the Mockup
Generate Extended Licenses
   License for given time periods
   License is independent in media streamer
   License account from registration date (Reload date by customer)
Block Access to internet per client

The type of the uploaded file would be based on its suffix as described above. Actual behavior of the file sent would be based on the support given by the phone, it's O.S and/or its browser.

The administrator may perform the following functions:
Select the client for whom he would want to see the data—or all clients.
Generate Activation Key and Define the media streamer in the system
Print the activation key to the printer
Generate License key and send it to the administrator email address

The roles of the media streamer are as follows:
Communication with Server
Blue tooth Communication
Wi-Fi Communication
Update Media streamer Software

Initially the media streamer would need to be activated to make it operable. This customer would be requested to turn the media streamer on and to hook it into internet connection. The media streamer will ping the server, and the server upon recognition will enable media streamer activation.

The Media streamer gets from the system information which directs it how to act. Also before each of such communication, the client sends the data to the server.

The information the Media streamer receives from the server is as follow:
Sync Interval—Time interval in second to communicate with server
Enable Flag—Whether or not the media streamer should function
Time zone of the media streamer—GMT offset for time
Campaign Information
Start Time and End Time
File to transfer: Image, Audio, Video, etc.
BT Priority—Nearest or FIFO
Interaction List of Campaign—For Media streamer Sharing mode only
URL for Campaign (For Wi-Fi)
Interaction Settings—Retry, resend and others

The following is the information the media streamer sends to the client:
The revision number of the software
The Interaction List: Mac, Date, Time, Response—Whatever is available
Ping the server to say “Alive”—For initial definition
Alive—Check if the server is available
Status—Status of the media streamer with any relevant information media streamer may have

As soon as the media streamer has active campaign to run, it would do the following operations:
Find all phones with BT available
Check based on Interaction list the action required
   Check if phone is in interaction list
   If no send request to phone
   If yes, check time from last interaction based on most recent response
For Each Phone it finds for which a message can be sent:
   Sends a request to send file to the phone for few seconds
   If not response, repeat request for few times
      Finally the following response may be for the request: Ignored, Yes, No.
Ignored: Repeat the request process
Yes, The file is sent to the phone, Repeat based on media streamer settings
No, Repeat the request based on Media streamer Settings
   The Media streamer tracks of these interactions with the following information:
Mac address of phone
Friendly Name of phone
Response: Ignore, Yes, No, Failed (If file sending failed after ‘YES’)

It is within provision of the invention that all media streamers send the list of mobile devices connected to the server at given time intervals. The media streamer as explained above is used as an access point for mobile devices which supports Wi-Fi. Once a potential end user for instance searches for a wireless access point, any local media streamers will for instance appear on that end user's list of available access points in keeping with the Wifi(tm)protocol. If the potential end user selects the Wi-Fi point associated with a media streamer of the system, s/he would see a landing page (initial web page) associated with an ad campaign running on the media streamer, the page for instance containing either an image of the campaign or a link (that may be represented by a button) to the actual file. The end user would be able to press a ‘continue’ button once the pre defined advertisement period ended, for instance, and gain access to the internet.

Note that the administrator may block internet access to all media streamers of its client. In which case, the will not grant internet access.

The media streamer would send once in a while a list of all MAC phone accessed the Wi-Fi network of the media streamer. Note that there is not Interaction list management of the Wi-Fi access as there was in the BT communication.

It is within provision of the invention that the media streamer software be able to get from the server a request for update. If received, the media streamer will stop its normal operation and start the update process. This process includes both downloading the updated software to the media streamer and installing it on the media streamer. Updating will only be executed between certain predefined hours such as between 3:00-500 AM. After that the media streamer will resume normal operation.

It is within provision of the invention that the following functionality be provided by software associated with the invention:
Ability to distinguish different devices and phone types
Ordering and payment for extended licenses
Advanced statistics—Trends per day and others Advertisers can view statistics with their own account
Advanced scheduling campaigns
License Management and Advanced functionality—Display, Track, etc.
Changes in Hardware
Security features for Media streamer and Server

Although selected embodiments of the present invention have been shown and described, it is to be understood the present invention is not limited to the described embodiments. Instead, it is to be appreciated that changes may be made to these embodiments without departing from the principles and spirit of the invention, the scope of which is defined by the claims and the equivalents thereof.

What is claimed is:

1. An advertising system comprising:
a. a plurality of media streamers adapted for providing wireless connectivity to mobile devices;
b. a server in networked communication with said media streamers;
c. a database of advertising content on said server;
whereby advertising content may be sent to mobile devices by means of media streamers.

2. The system of claim 1 wherein said wireless connectivity is selected from the group consisting of: BlueTooth®, WiFi™, infrared, optical.

3. The system of claim 1 wherein said mobile devices are selected from the group consisting of: Turing machine, cellphone, smartphone, PDA, laptop computer, desktop computer, tablet computer.

4. The system of claim 1 wherein said advertising content is selected from the group consisting of: html pages, images, video, text, audio, url.

5. The system of claim 1 wherein said server is provided with software associated with said advertising system adapted to serve said advertising content to said media streamers, and further adapted to let advertisers manipulate said advertising content.

6. The system of claim 1 wherein said media streamers are organized into zones, these being logical groups of media streamers.

7. The system of claim 1 wherein said advertising content is sent to said mobile devices by said media streamers based on criteria selected from the group consisting of: MAC address, media streamer location, mobile device connection history.

8. The system of claim 1 wherein said media streamers are adapted to query said mobile devices regarding connection details selected from the group consisting of: whether to connect; connection speed; connection protocol; connection language.

9. The system of claim 1 wherein said media streamers are adapted to record information selected from the group consisting of: mobile device MAC address, mobile device vendor and model, mobile device operating system, mobile device software information, mobile device query response.

10. The system of claim 1 wherein advertisers may modify said advertising content.

11. A method of mobile advertising comprising steps of:
a. a plurality of media streamers adapted for providing wireless connectivity to mobile devices;
b. a server in networked communication with said media streamers;
c. a database of advertising content on said server;
whereby advertising content may be sent to mobile devices by means of media streamers.

12. The method of claim 11 wherein said wireless connectivity is selected from the group consisting of: BlueTooth®, WiFi™, infrared, optical.

13. The method of claim 11 wherein said mobile devices are selected from the group consisting of: Turing machine, cellphone, smartphone, PDA, laptop computer, desktop computer, tablet computer.

14. The method of claim 11 wherein said advertising content is selected from the group consisting of: html pages, images, video, text, audio.

15. The method of claim 11 wherein said server is provided with software associated with said advertising system adapted to serve said advertising content to said media streamers, and further adapted to let advertisers manipulate said advertising content.

16. The method of claim 11 wherein said media streamers are organized into zones, these being logical groups of media streamers.

17. The method of claim 11 wherein said advertising content is sent to said mobile devices by said media streamers based on criteria selected from the group consisting of: MAC address, media streamer location, mobile device connection history.

18. The method of claim 11 wherein said media streamers are adapted to query said mobile devices regarding connection details selected from the group consisting of: whether to connect; connection speed; connection protocol;
connection language.

19. The method of claim 11 wherein said media streamers are adapted to record information selected from the group consisting of: mobile device MAC address, mobile device type, mobile device operating system, mobile device software information, mobile device query response.

20. The method of claim 11 wherein advertisers may modify said advertising content.
